(19) United States
(12) Patent Application Publication
(10) Pub. No.: US 2006/0105143 A1
(43) Pub. Date: May 18, 2006

(54) Apertured film abrasive wipes

(75) Inventors: Kyra Darnella Dorsey, Greensboro, NC (US); A. Frank Baldwin JR., Greensboro, NC (US); Barbara Lemons, Greensboro, NC (US); Michael J. Shaltry, Greensboro, NC (US)

Correspondence Address: MYERS BIGEL SIBLEY & SAJOVEC, PO BOX 37428, RALEIGH, NC, 27627, US

(73) Assignee: Precision Fabrics Group, Inc.

(21) Appl. No.: 11/251,719

(22) Filed: Oct. 17, 2005

Related U.S. Application Data
(60) Provisional application No. 60/621,152, filed on Oct. 22, 2004.

(51) Int. Cl. B32B 3/10

(52) U.S. Cl. 428/137; 428/131

(57) ABSTRACT

A cleaning wipe includes a layer of apertured film having opposite first and second surfaces. Each aperture has a generally rigid protuberance that extends outwardly from the first surface of the layer of apertured film. A layer of soft material is bonded to the second surface of the layer of apertured film in face-to-face relationship. A cleaning wipe may include first and second layers of apertured film with a layer of soft material sandwiched therebetween. The protuberances may have a generally conical shape and the layer of soft material may be impregnated with one or more chemical ingredients.

### RELATED APPLICATION

This application claims the benefit of and priority to U.S. Provisional Patent Application No. 60/621,152 filed Oct. 22, 2004, the disclosure of which is incorporated herein by reference as if set forth in its entirety.

### FIELD OF THE INVENTION

The present invention relates generally to cleaning products and, more particularly, to cleaning products for wiping surfaces.

### BACKGROUND OF THE INVENTION

Cleaning wipes have been used for a variety of purposes, including body cleaning, cleaning of hard surfaces, cleaning dishware, flatware, pots and pans, etc. Conventional cleaning wipes may contain various compounds to accomplish their intended purpose. For example, cleaning wipes may include inverse emulsions (i.e., water-in-liquid) to clean infants. Cleaning wipes may also include waxes to polish and clean furniture, soaps and detergents to clean hands, counter tops, floors, and the like. Cleaning wipes may also include ammonia to clean glass surfaces. Alcohol and various other biocides may be included to disinfect a variety of surfaces.

Conventional cleaning wipes are typically soft and may not work well in applications where some amount of scrubbing is necessary to clean a surface. As such, there is a need for cleaning wipes that can be used to scrub surfaces.

### SUMMARY OF THE INVENTION

In view of the above discussion, a cleaning wipe, according to embodiments of the present invention, includes a layer of apertured film having opposite first and second surfaces. Each aperture has a generally rigid protuberance that extends outwardly from the first surface of the layer of apertured film. A layer of soft material is bonded to the second surface of the layer of apertured film in face-to-face relationship. The protuberances have a generally conical shape; however, other shapes and configurations may be utilized. The second surface of the layer of apertured film is generally smooth, and the first surface is rough and abrasive, due to the protuberances. The layer of soft material may be impregnated with one or more chemical ingredients. Exemplary chemical ingredients include, but are not limited to, cleaning solutions, soaps, antiseptics, surfactants, antimicrobial agents, detergents, bleach, polishes, facial cleansers, etc.

According to embodiments of the present invention, a cleaning wipe includes first and second layers of apertured film with a layer of soft material sandwiched therebetween. The first layer of apertured film has opposite first and second surfaces with the apertures having generally rigid protuberances that extend outwardly from the first surface. The second layer of apertured film has opposite first and second surfaces and apertures have generally rigid protuberances that extend outwardly from the first surface. The layer of soft material is bonded to the respective second surfaces of the first and second layers of apertured film in face-to-face relationship. The protuberances have a generally conical shape; however, other shapes and configurations may be utilized. The first and second layers of apertured film may be formed from the same film material or may be formed from different material. In addition, the protuberance configuration and numbers of apertures in the first and second layers of apertured film may be the same or different. The layer of soft material may be virtually any type of material and may be absorbent and/or may include one or more chemical ingredients including, but not limited to, cleaning solutions, soaps, antiseptics, surfactants, antimicrobial agents, detergents, bleach, polishes, facial cleansers, etc.

According to embodiments of the present invention, a cleaning wipe includes a layer of apertured film having opposite first and second surfaces. Each aperture has a generally rigid protuberance that extends outwardly from the first surface of the layer of apertured film. A layer of soft material is bonded to the second surface of the layer of apertured film in face-to-face relationship. The protuberances may have a generally conical shape; however, other shapes and configurations may be utilized. A layer of liquid impervious film is bonded to the layer of soft material in face-to-face relationship. The layer of apertured film and the layer of liquid impervious film may be formed from the same material or may be formed from different materials. The layer of soft material may be virtually any type of material and may be absorbent and/or may include one or more chemical ingredients including, but not limited to, cleaning solutions, soaps, antiseptics, surfactants, antimicrobial agents, detergents, bleach, polishes, facial cleansers, etc.

### BRIEF DESCRIPTION OF THE DRAWINGS

FIGS. 1-3 are cross-sectional views of cleaning wipes according to embodiments of the present invention.

### DETAILED DESCRIPTION OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise. All publications, patent applications, patents, and other references mentioned herein are incorporated herein by reference in their entireties.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a “first” element, component, region, layer or section discussed below could also be termed a “second” element, component, region, layer or section without departing from the teachings of the present invention.

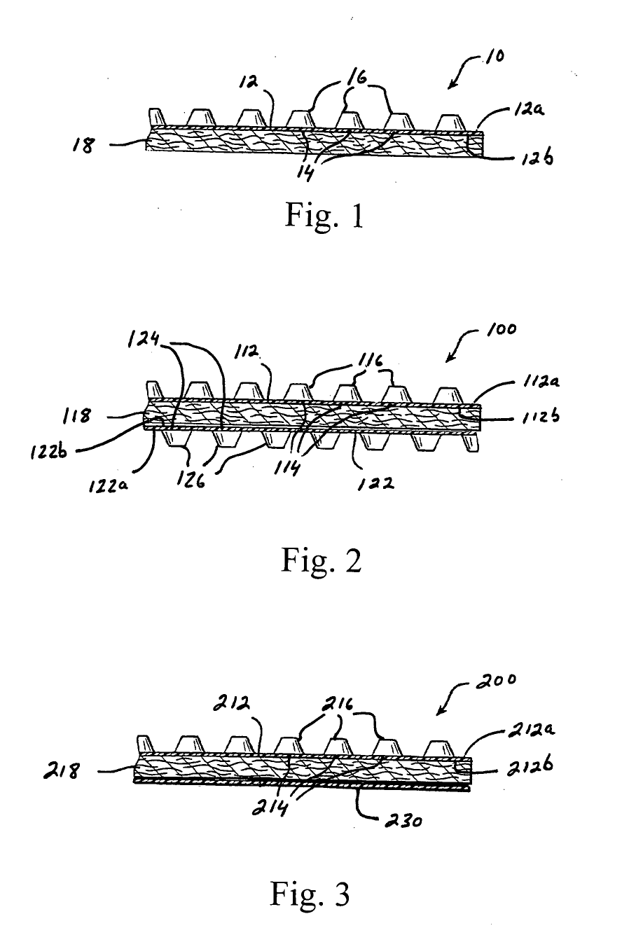

Referring to FIG. 1, a cleaning wipe 10, according to embodiments of the present invention, includes a layer of apertured film 12 having opposite first and second surfaces 12a, 12b. Each aperture 14 has a generally rigid protuberance 16 that extends outwardly from the first surface 12a of the layer of apertured film 12. A layer of soft material 18 is bonded to the second surface 12b of the layer of apertured film 12 in face-to-face relationship, as illustrated. The protuberances 16 have a generally conical shape in the illustrated embodiment; however, other shapes and configurations may be utilized.

Apertured films are well known in the art and are formed by extruding a thermoplastic material in sheet form and then processing the film, for example, over a perforated vacuum drum. The soft thermoplastic is drawn through the apertures in the drum and protuberances on one side of the film are formed. If the vacuum process is continued, the protuberances break open and leave a conical shaped perforation in the film. An exemplary apertured film that may be utilized according to embodiments of the present invention includes VISPORE® apertured film supplied by Tredegar (Richmond, Va.). Such apertured films include, but are not limited to, those available commercially under the designations Tredegar X-6799, Tredegar X-6845, Tredegar X-6923, Tredegar X-6944, and Tredegar X-6844. Furthermore, an exemplary apertured film, according to embodiments of the present invention, has a basis weight in the range of 15-100 grams per square meter (gsm). Moreover, apertures in an exemplary apertured film, according to embodiments of the present invention, have a size ranging from between about 10 microns and about 200 microns, and the number of apertures per square centimeter of apertured film ranges from between about 5 apertures to about 100 apertures. Apertured films having different aperture sizes and different numbers of apertures per square centimeter may be utilized. Embodiments of the present invention are not limited to the above range of aperture size or to the range of numbers of apertures per square centimeter.

The second surface 12b of the layer of apertured film 12 is generally smooth, and the first surface 12a is rough and abrasive, due to the protuberances 16. Apertured films utilized in accordance with embodiments of the present invention may be made from any polymeric material including, but not limited to, polyethylene, polypropylene, and copolymers thereof.

The layer of soft material 18 may include woven material, nonwoven material, paper, film, sponge, foam and/or combinations of these materials. In addition, the layer of soft material 18 may be a composite of a plurality of layers of material. According to a particular embodiment of the present invention, the layer of soft material 18 is a spunlace material, such as 40 gsm PE/PET bicomponent fiber spunlace material.

According to an embodiment of the present invention, the layer of soft material 18 may be absorbent or may include absorbent material, such as rayon. According to an embodiment of the present invention, the layer of soft material 18 may be resilient or may include resilient material such that the wipe 10 maintains its shape after use.

According to other embodiments of the present invention, the layer of soft material 18 may be impregnated with one or more chemical ingredients. Exemplary chemical ingredients include, but are not limited to, cleaning solutions, soaps, antiseptics, surfactants, antimicrobial agents, detergents, bleach, polishes, facial cleansers, etc.

The layer of soft material 18 may be bonded to the second surface 12b of the layer of apertured film 12 in various ways including, but not limited to, thermally bonded, adhesively bonded, bonded via RF welding, bonded via stitching, etc.

Referring to FIG. 2, a cleaning wipe 100 according to another embodiment of the present invention includes first and second layers 112, 122 of apertured film with a layer of soft material 118 sandwiched therebetween. The first layer of apertured film 112 has opposite first and second surfaces 112a, 112b with the apertures 114 having generally rigid protuberances 116 that extend outwardly from the first surface 112a. The second layer of apertured film 122 has opposite first and second surfaces 122a, 122b and apertures 124 have generally rigid protuberances 126 that extend outwardly from the first surface 122a. The layer of soft material 118 is bonded to the respective second surfaces 112b, 122b of the first and second layers of apertured film 112, 122 in face-to-face relationship, as illustrated. The protuberances 116, 126 have a generally conical shape in the illustrated embodiment; however, other shapes and configurations may be utilized.

The first and second layers of apertured film 112, 122 may be formed from the same film material or may be formed from different material. In addition, the protuberance configuration and numbers of apertures in the first and second layers of apertured film 112, 122 may be the same or different. The layer of soft material 118 may be virtually any type of material and may be absorbent and/or may include one or more chemical ingredients as described above with respect to embodiments of FIG. 1. Aperture size and numbers of apertures per square centimeter may be similar to the embodiment of FIG. 1 or may be different.

Referring to FIG. 3, a cleaning wipe 200 according to another embodiment of the present invention includes a layer of apertured film 212 having opposite first and second surfaces 212a, 212b. Each aperture 214 has a generally rigid protuberance 216 that extends outwardly from the first surface 212a of the layer of apertured film 212. A layer of soft material 218 is bonded to the second surface of the layer of apertured film 212 in face-to-face relationship, as illustrated. The protuberances 216 have a generally conical shape in the illustrated embodiment; however, other shapes and configurations may be utilized. A layer of liquid impervious film 230 is bonded to the layer of soft material 218 in face-to-face relationship, as illustrated.

The layer of apertured film 212 and the layer of liquid impervious film 230 may be formed from the same material or may be formed from different materials. The layer of soft material 118 may be virtually any type of material and may be absorbent and/or may include one or more chemical ingredients as described above with respect to embodiments of FIG. 1. Aperture size and numbers of apertures per square centimeter may be similar to the embodiment of FIG. 1 or may be different.

Applications for cleaning wipes according to embodiments of the present invention include dishcloths, pot & pan scrubbers, kitchen and bath cleaning wipes, body and facial exfoliating wipes, and any application which requires some amount of abrasion and a soft absorbent side to assist in cleaning. The following examples are provided to illustrate embodiments of the present invention, and should not be construed as limiting thereof.

### EXAMPLE 1

A layer of 40 gsm Tredegar apertured PE film is bonded to one layer of 40 gsm PE/PET bicomponent fiber spunlace material with aperture protuberances facing outward. The PE sheath surrounding the PET spunlace fibers facilitates bonding to the PE apertured film.

### EXAMPLE 2

A layer of 40 gsm Tredegar apertured PE film is bonded to one layer of 40 gsm PE/PET bicomponent fiber spunlace material with aperture protuberances facing outward. A Branson 900 series ultrasonic bonder is used to bond the apertured film and spunlace material together with process conditions of 40 psi at 70% amplitude at 20 ft/min.

### EXAMPLE 3

A layer of 40 gsm Tredegar apertured PE film is bonded to two layers of 40 gsm PE/PET bicomponent fiber spunlace material with aperture protuberances facing outward. A Branson 900 series ultrasonic bonder is used to bond the apertured film and spunlace material together with process conditions of 70 psi at 75% amplitude at 20 ft/min. An index 2000 pattern is used.

### EXAMPLE 4

A layer of 40 gsm Tredegar apertured PE film is bonded to two layers of 40 gsm PE/PET bicomponent fiber spunlace material with aperture protuberances facing outward. A thermal calendar containing one smooth roll and one roll engraved with an index pattern is used. Process conditions are 600 psi, 35 ft/min, an engraved roll temperature of 254° F. and a smooth roll temperature of 260° F. The apertured film faces the engraved roll and the spunlace layers face the smooth roll.

### EXAMPLE 5

A layer of 40 gsm Tredegar apertured PE film is thermally bonded to two and three layers of 40 gsm PE/PET bicomponent fiber spunlace material with aperture protuberances facing outward. A thermal calendar containing one smooth roll and one roll engraved with an index pattern is used to bond the apertured film to the layers of spunlace material. Process conditions are 800 psi, 50 ft/min, an engraved roll temperature of 228° F. and a smooth roll temperature of 265-278° F. The apertured film faces the engraved roll and the spunlace layers face the smooth roll.

### EXAMPLE 6

A layer of 36.8 gsm blue AquiDry apertured film by Tredegar is thermally bonded to two or three layers of 40 gsm spunlace material containing 50% PE/PET bicomponent fiber made by Kosa and 50% rayon with aperture protuberances facing outward. A thermal calendar containing one smooth roll and one roll engraved with an index pattern is used to bond the apertured film to the spunlace material. The apertured film faces the engraved roll and the spunlace layers face the smooth roll. Tables 1 and 2 below set forth the process conditions as well as resulting properties. All composites are bonded using 600 pLi of pressure and using the engraved pattern index 2000.

TABLE 1
Process Conditions

| | Engraved | Smooth | Set Temperature (F.) | | Actual Temperature (F.) | | Pressure | Speed |
|---|---|---|---|---|---|---|---|---|
| Sample | Layer A | Layer B | Engraved | Smooth | Engraved | Smooth | pLi | ft/min |
| 091203-01 | 1 layer | 3 layers of | 250 | 260 | 235 | 250 | 600 | 75 |
| 091203-02 | of #30231; | #00641; | 270 | 280 | 255 | 270 | 600 | 75 |
| 091203-03 | Tredegar | SX-415; | 270 | 280 | 255 | 270 | 600 | 150 |
| 091203-04 | Lt. Blue | 50% PE/PET | 270 | 280 | 255 | 270 | 600 | 300 |
| 091203-05 | AquiDry | bico/50% | 270 | 295 | 255 | 285 | 600 | 300 |
| 640239807 | 36.8 gsm | Rayon SL; | 270 | 295 | 255 | 285 | 600 | 300 |
| 640239810 | | 40 gsm | 270 | 295 | 255 | 285 | 600 | 300 |
| 091203-06 | | | 270 | 295 | 255 | 285 | 600 | 500 |
| 640239815 | | 2 layers | 270 | 295 | 255 | 285 | 600 | 300 |

TABLE 2
Product properties

| | Grab Tensile | | Bond Strength | | | | |
|---|---|---|---|---|---|---|---|
| | (lb) | | (g/in) | | Absorbent Capacity | | |
| Sample | MD | CD | MD | CD | g (per 5 g wt) | g/g | Rate |
| 091203-01 | 22 | | 107 | | 25 | 5.0 | 2.81 |
| 091203-02 | 25 | 12 | 285 | | 22 | 4.4 | 5.5 |
| 091203-03 | 22 | 13 | 214 | 232 | 24 | 4.8 | 3.69 |
| 091203-04 | 20 | 10 | 158 | 163 | 24 | 4.8 | 3.03 |
| 091203-05 | | | | | | | |
| 640239807 | 24 | 11 | 137 | 168 | 26 | 5.1 | |
| 640239810 | 22 | 11 | 108* | 114* | 24 | 4.9 | |
| 091203-06 | 20 | 10 | 139 | 130 | 24 | 4.8 | 3.03 |
| 640239815 | 15 | 9 | 170 | 105.9/ | 32 | 6.3 | |
| | | | | destruct | | | |

The foregoing is illustrative of the present invention and is not to be construed as limiting thereof. Although a few exemplary embodiments of this invention have been described and several examples provided, those skilled in the art will readily appreciate that many modifications are possible in the exemplary embodiments without materially departing from the novel teachings and advantages of this invention.

That which is claimed is:

1. A cleaning wipe, comprising:
a layer of apertured film having opposite first and second surfaces, wherein each aperture has a generally rigid protuberance that extends outwardly from the first surface of the layer of film; and
a layer of soft material bonded to the second surface of the layer of apertured film in face-to-face relationship.

2. The cleaning wipe of claim 1, wherein the protuberances have a generally conical shape.

3. The cleaning wipe of claim 1, wherein the layer of soft material comprises material selected from the group consisting of woven, nonwoven, paper, film, sponge and foam.

4. The cleaning wipe of claim 1, wherein the layer of soft material comprises spunlace material.

5. The cleaning wipe of claim 4, wherein the spunlace material comprises 40 gsm PE/PET bicomponent fiber spunlace material.

6. The cleaning wipe of claim 1, wherein the layer of soft material is ultrasonically bonded to the second surface of the layer of apertured film.

7. The cleaning wipe of claim 1, wherein the layer of soft material is thermally bonded to the second surface of the layer of apertured film.

8. The cleaning wipe of claim 1, wherein the layer of soft material is adhesively bonded to the second surface of the layer of apertured film.

9. The cleaning wipe of claim 1, wherein the layer of soft material is bonded to the second surface of the layer of apertured film via RF welding.

10. The cleaning wipe of claim 1, wherein the layer of soft material is bonded to the second surface of the layer of apertured film via stitching.

11. The cleaning wipe of claim 1, wherein the layer of apertured film comprises film having a basis weight of between about 15 gsm and about 100 gsm.

12. The cleaning wipe of claim 1, wherein the layer of apertured film comprises thermoplastic film.

13. The cleaning wipe of claim 1, wherein the layer of soft material comprises an absorbent material.

14. The cleaning wipe of claim 1, wherein the layer of soft material comprises a resilient material.

15. The cleaning wipe of claim 13, wherein the absorbent material comprises rayon.

16. The cleaning wipe of claim 1, wherein the layer of soft material is impregnated with one or more chemical ingredients selected from the group consisting of cleaning solutions, soaps, antiseptics, surfactants, antimicrobial agents, detergents, bleach, polishes, and facial cleansers.

17. The cleaning wipe of claim 1, wherein the layer of soft material comprises a plurality of layers of soft material.

18. The cleaning wipe of claim 1, wherein the apertures in the layer of apertured film have a size ranging from between about 10 microns and about 200 microns.

19. The cleaning wipe of claim 1, wherein the number of apertures per square centimeter of apertured film ranges from between about 5 apertures to about 100 apertures.

20. A cleaning wipe, comprising:
a first layer of apertured film having opposite first and second surfaces, wherein each aperture has a generally rigid protuberance that extends outwardly from the first surface of the first layer of apertured film;
a second layer of apertured film having opposite first and second surfaces, wherein each aperture has a generally rigid protuberance that extends outwardly from the first surface of the second layer of apertured film; and
a layer of soft material sandwiched between the first and second layers of apertured film, wherein the layer of soft material is bonded to the respective second surfaces of the first and second layers of apertured film in face-to-face relationship.

21. The cleaning wipe of claim 20, wherein the layer of soft material is impregnated with one or more chemical ingredients selected from the group consisting of cleaning solutions, soaps, antiseptics, surfactants, antimicrobial agents, detergents, bleach, polishes, and facial cleansers.

22. A cleaning wipe, comprising:
a layer of apertured film having opposite first and second surfaces, wherein each aperture has a generally rigid protuberance that extends outwardly from the first surface of the layer of film;
a layer of soft material bonded to the second surface of the layer of apertured film in face-to-face relationship; and
a layer of liquid impervious film bonded to the layer of soft material in face-to-face relationship.

23. The cleaning wipe of claim 22, wherein the layer of soft material is impregnated with one or more chemical ingredients selected from the group consisting of cleaning solutions, soaps, antiseptics, surfactants, antimicrobial agents, detergents, bleach, polishes, and facial cleansers.
